(19) United States
(12) Patent Application Publication
(10) Pub. No.: US 2013/0091192 A1
(43) Pub. Date: Apr. 11, 2013

(54) ASYNCHRONOUS MESSAGING BUS

(71) Applicants: Mohammed Saleem Shafi, Austin, TX (US); Steven Jeromy Carriere, Palo Alto, CA (US); Michael Taylor Clay, Austin, TX (US)

(72) Inventors: Mohammed Saleem Shafi, Austin, TX (US); Steven Jeromy Carriere, Palo Alto, CA (US); Michael Taylor Clay, Austin, TX (US)

(21) Appl. No.: 13/270,978

(22) Filed: Oct. 11, 2011

(51) Int. Cl. G06F 15/16

(52) U.S. Cl. 709/202; 709/204

(57) ABSTRACT

Techniques for event message processing are presented. Embodiments may receive an event message from a first capability. The event message may include a header and a payload. Embodiments may then parse the header of the event message to identify a topic of the event message. Embodiments also identify a tenant identifier associated with the event message. Using the topic and the tenant identifier, embodiments may determine that a second capability is to receive the event message. Accordingly, embodiments send the event message to the second capability.

### FIELD

Embodiments of the present application relate generally to message processing, and more particularly, to techniques for processing event messages in a networked environment.

### BACKGROUND

Business is increasingly being conducted in an electronic environment over network connections. This has rapidly increased the speed with which business is conducted but has also presented a number of challenges for the infrastructure that supports these business transactions.

For example, typical business transaction architectures may integrate a number of services offered by multiple service providers. However, such integrated services usually involve point-to-point integration between the specific service providers. As a result, typical business transaction architectures involve a tightly coupled set of services that perform services on behalf of end users and/or merchants.

Because of the tight coupling between, for example, a business platform and the services offered therein, changes within the infrastructure typically must be propagated throughout the infrastructure or the services must be integrated directly with each other. For example, if a merchant lists items for sale on a listing service and performs payments using a payment service, the merchant generally must integrate the two services to each other. However, if the merchant adds a third service, say an inventory service, then the merchant will then need to integrate all three services to each other. Such an effort is error prone and costly in terms of development, time, and money.

### BRIEF DESCRIPTION OF THE DRAWINGS

Embodiments of the present application are illustrated by way of example and not limitation in the figures of the accompanying drawings, in which like references indicate similar elements.

FIG. 1 is a diagram of a message processing system, according to an example embodiment.

FIG. 2 is a block diagram showing components of a capability, according to an example embodiment.

FIG. 3 is a block diagram showing example modules of a messaging fabric, according to an example embodiment.

FIG. 4 is a figure showing example routing data that may be maintained by the messaging manager, according to an example embodiment.

FIG. 5 is a block diagram that shows a format for an event message that may be communicated between components of various embodiments.

FIG. 6 is a diagram of a method of authorizing a capability to publish and/or receive event messages on behalf of a tenant, as may be performed by various embodiments.

FIG. 7 is a sequence diagram that illustrates a method for transmitting event messages between various capabilities, according to an example embodiment.

FIG. 8 is a block diagram that shows a synchronous bridge that exchanges event messages between a capability and a messaging fabric, according to an example embodiment.

FIG. 9 is a block diagram that shows an example system that utilizes a message relay to communicate event messages to a capability, according to an example embodiment.

FIG. 10 is a diagram of an example network-based commerce system or facility which implements various embodiments.

FIG. 11 is a diagram that illustrates a number of services that may be communicatively connected to the messaging fabric, according to various embodiments.

FIG. 12 is a diagram of example services 1200 implemented within some of the capabilities 1030 of the network-based commerce system 1000 of FIG. 10.

FIG. 13 is a diagram of machine architecture which implements various aspects of the invention, according to an example embodiment.

### DETAILED DESCRIPTION

Methods and systems for processing event messages are described. In the following description, for purposes of explanation, numerous specific details are set forth in order to provide a thorough understanding of embodiments of the invention. It will be evident, however, to one of ordinary skill in the art that other embodiments of the invention may be practiced without these specific details.

Embodiments employ a messaging fabric that receives and routes event messages published by tenants (e.g., merchants) or capabilities (e.g., web services—eBay, Amazon, PayPal, fulfillment, shipping, order processing, etc.). When the messaging fabric receives an event message, the messaging fabric performs route negotiation with the help of a messaging manager. The messaging manager maintains routing data that maps capabilities (e.g., web services), topics, and tenants. When the received event message header is parsed by the messaging fabric, the topic is extracted from the event message header and compared to the mappings between capabilities (e.g., web services), topics, and tenants to determine which capabilities should receive the message.

### Example Systems and Components

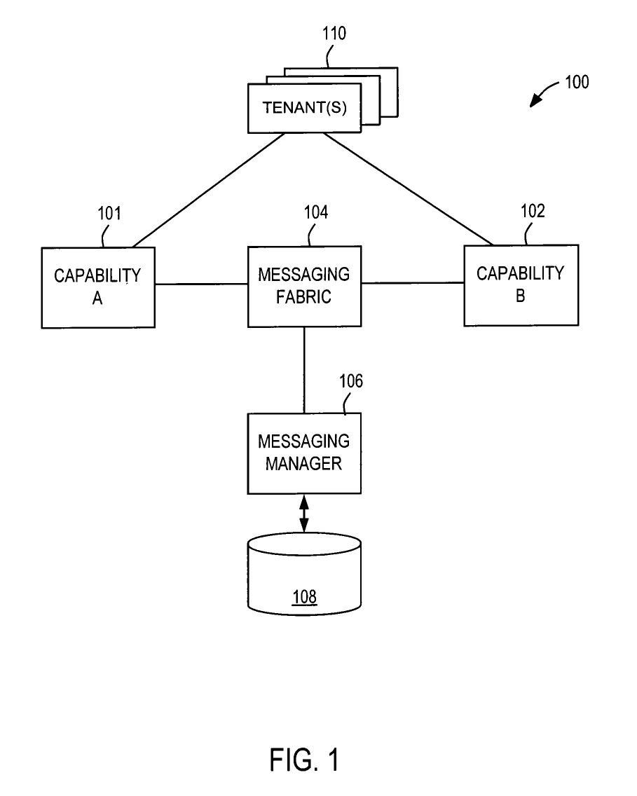

FIG. 1 is a diagram of a message processing system 100, according to an example embodiment. The message processing system 100 is implemented in a machine-accessible and/or readable medium, performed by computer systems, and is accessible over a network. The network may be wired, wireless, or a combination of wired and wireless. In an embodiment, the message processing system 100 is implemented as a business transaction infrastructure over the Internet or any other suitable network, and is accessible to and interacts with buyers, sellers, service providers, and commerce applications to facilitate business transactions between the buyers and merchants.

The message processing system 100 includes capabilities 101 and 102 communicatively coupled to a messaging fabric 104 that is communicatively coupled to a messaging manager 106. As FIG. 1 shows, the messaging manager 106 is, in turn, communicatively coupled to a routing store 108. Still further, FIG. 1 shows that the capabilities 101, 102 are associated with a plurality of tenants 110.

The capabilities 101 and 102 may be configured to provide services to tenants 110. According to various embodiments, the capabilities 101, 102 may be a network-addressable computing system that runs applications, web services, and/or application programming interfaces (APIs) that are accessible to the tenants 110. A service that lists an item on a web-site is an example of a service that may be provided by the capabilities 101, 102. Payment authorization and/or authentication, inventory management, order tracking, store front management, and any other suitable service are additional examples of services that may be provided by the capabilities 101, 102. In some embodiments, the capability 101 may provide a service that is different than the service provided by capability 102. For example, the capability 101 may provide a store front service, whereas the capability 102 may provide a payment service.

The tenants 110 may be computing systems operated by an end-user or associated with an end-user system. Examples of tenants in an e-commerce environment are merchants and merchant systems that sell and/or buy goods.

The messaging fabric 104 may be a computer system that provides a messaging infrastructure that allows the capabilities to interact by exchanging event messages. In particular, the messaging fabric 104 may route event messages that are decoupled from the capability that is to receive the event message. For example, an event message that does not include an identifier or address that uniquely identifies the capability that is to receive the event message is an example of an event message that is decoupled from the receiving capability.

Still with reference to FIG. 1, the messaging fabric 104 is communicatively coupled to the messaging manager 106. The messaging manager 106, according to example embodiments, may be a computer system that manages routing data used to determine a route for an event message. For example, the messaging manager 106 may access a routing data store 108, which may be a database system that manages tables or any other data structure that defines the relationships between topics, capabilities, and tenants. As used herein, a “topic” may refer to a classification of an event message. As will be explained below, event messages may include a topic to indicate the classification of the information contained therein. Further, a capability may use a topic to indicate the classification of event messages that it is interested in receiving.

Although FIG. 1 shows the various components of the message processing system 100 as separate computing systems, it should be appreciated that one or more of the components of the message processing system 100 may reside within the same computer system. For example, the messaging fabric 104 and the messaging manager 106 may be employed within the same computer system.

As an illustration of the operation of the message processing system 100, capability 101 may send an event message, in response to a detected change of state or an explicit request, to capability 102 via the massaging fabric 104. Upon receiving the event message, the messaging fabric 104 may determine that the capability 102 is to receive the event message. Such a determination may be based on the routing data store 108, as is managed by the messaging manager 106. For example, the routing data store 108 may map a topic and a tenant identifier associated with the event message to the capability 102.

It is to be appreciated that that system 100 provides a loosely coupled event message exchange system where the event messages are exchanged by the capabilities 101, 102 on behalf of the tenants 110. Such a loosely coupled event messaging exchange system is achieved because, as described above, the capabilities send event messages to each other without including any destination information in the event messages themselves. Using such a loosely coupled event message exchange system, the tenant 110 may authorize a capability to send event messages without having to integrate the sending capability with each receiving capability.

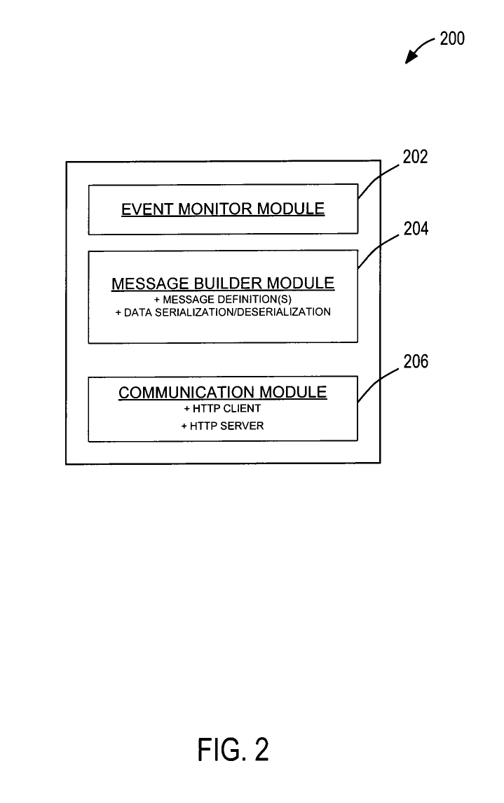

The components of the system 100 are now described in greater detail. FIG. 2 depicts a block diagram of the various modules, in accordance with an example embodiment, that may be included in a capability 200. It should be appreciated that the capability 200 may be deployed in the form of, for example, one or more of a server computer, a client computer, a personal computer, a laptop computer, a mobile phone, a personal digital assistant, and other computer systems. In one embodiment, the capability 200 may be embodied as the capability 101 of the event message processing system 100 depicted in FIG. 1. In an alternate embodiment, the capability 200 may be embodied as the capability 102 of the same event message processing system 100. Referring to FIG. 2, in various embodiments, the capability 200 may be used to implement computer programs, logic, applications, methods, processes, or software to receive or send event messages, as described in more detail below.

As FIG. 2 shows, the capability 200 may include an event monitor module 202, a message builder module 204, and a communication module 206. The event monitor module 202 may monitor a business infrastructure for conditions that trigger the capability to send an event message to the messaging fabric 104. Such a condition, herein referred to as an “event condition,” may be caused when the event monitor module 202 detects an explicit request from a tenant or another system (e.g., a request to list an item for sale), or may be based on a detected event, such as a change of a price, a sale of an item, a completion of an order, a creation of an account, etc. When such a condition is detected, the event monitor module 202 may trigger the generation of one or more event messages to be sent to the messaging fabric 104.

The message builder module 204 may generate and format an event message that is to be sent to the messaging fabric 104 in response to the event monitor module 202 detecting an event condition. For example, the event monitor module 202 may cause the message builder module 204 to generate and format an event message in response to a user creating a listing on the capability 101. The message builder module 204 may utilize message definitions to generate and format the event message according to an expected format.

As is described below, an event message may include a header and a payload. The payload may refer to the data that is to be used by the service. In some embodiments, the message builder module 204 may serialize the payload of the data using Apache Avro™. Avro™ is a remote procedure call and serialization framework that uses JavaScript Object Notation (JSON) for defining data type and protocols. According to Avro™, the data structures stored in the payload may be serialized into a comparatively compact binary format. Although embodiments described herein may utilize Avro™, it is to be appreciated that other embodiments may use other protocols including, for example, protocols that include schema information in the message, thereby allowing the message structures to evolve independently of the modules that communicate the messages.

The message builder module 204 may also be used to deserialize a payload of an event message received from the messaging fabric 104. Deserializing a payload may involve transforming a comparatively compact binary format into a format suitable for processing in a computer environment, as may be defined by a message definition. Similar to serializing a payload, the message builder module 204 may deserialize the payload according to a message definition and/or the Avro™ framework.

The communication module 206 may transmit the event message to a messaging fabric 104. Additionally, the communication module 206 may receive the event message sent from the messaging fabric 104. In some embodiments, the communication module 206 operates according to a standard protocol, such as HTTP, HTTPS, UDP, IPC, CORBA or any other remote procedural call.

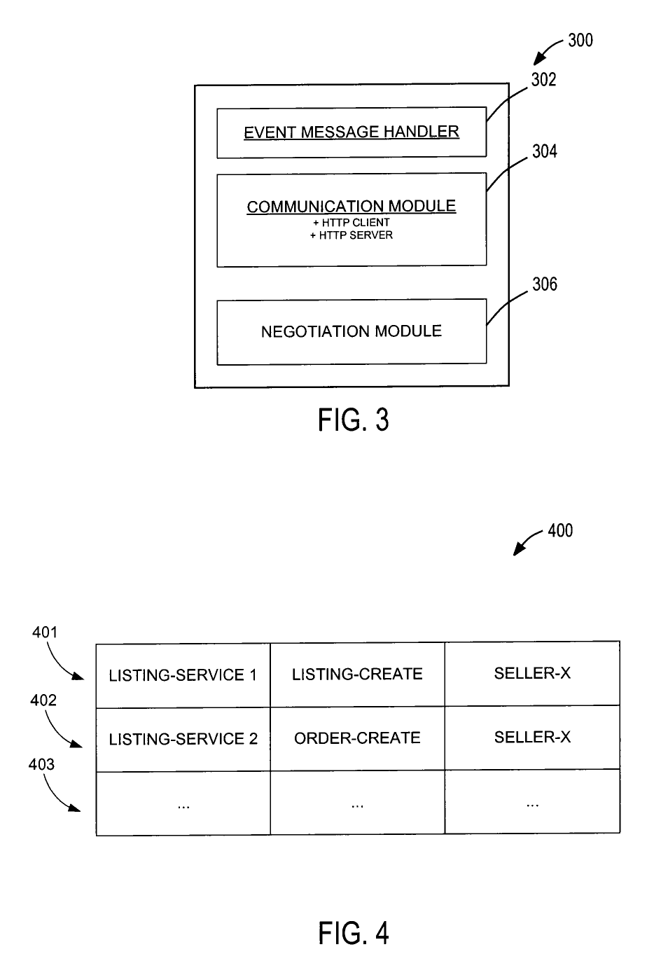

FIG. 3 depicts a block diagram of the various modules, in accordance with an example embodiment, that may be included in a messaging bus 300. The messaging bus 300 may be employed by the messaging fabric 104, the messaging manager 106, or some combination thereof. It should be appreciated that the messaging bus 300 may be deployed in the form of, for example, one or more of a server computer, a client computer, a personal computer, a laptop computer, a mobile phone, a personal digital assistant, and other computer systems. In various embodiments, the modules of the messaging bus 300 may be used to implement computer programs, logic, applications, methods, processes, or software to receive or send event messages, as described in more detail below. As FIG. 3 shows, the messaging bus 300 may include an event message handler 302, a communication module 304, and a negotiation module 306.

The communication module 304 may perform the operations of transmitting and receiving event messages to and from capabilities 101, 102. In some embodiments, the communication module 206 operates according to a standard protocol, such as HTTP, HTTPS, UDP, IPC, CORBA or any other remote procedural call.

The event message handler 302 may validate and route event messages to capabilities in response to the messaging fabric 104 receiving an event message. To perform the validation and routing functions, the event message handler 302 may parse the header of an event message to determine the capability that published the event message and to determine the capabilities that should receive the event message. The operations involved in validating and routing event messages are described in further detail below.

The negotiation module 306 may authorize and authenticate that a particular capability has authority to either publish an event message or receive an event message on behalf of a particular tenant. When the negotiation module 306 authorizes a capability to participate in the event messaging system 100 on behalf of a tenant, the negotiation module 306 may assign an authorization token to the capability. As is described below, the authorization token is specific to a tenant and a capability. The operations involved in authorizing a capability for such activities are described in greater detail below.

### Example Routing Data

FIG. 4 is diagram showing example routing data 400 that may be maintained by the messaging manager 106 in the routing data store 108.

In particular, the routing data 400 may include routing rows 401-403 that each includes a capability identifier, a topic, and a tenant identifier. The routing rows 401 store information that facilitates the determination of the destinations for a particular event message. For example, routing row 401 associates together a capability identifier (e.g., LISTING-SERVICE 1), a topic identifier (e.g., LISTING-CREATE), and a tenant identifier (e.g., SELLER-X). Accordingly, when an event message is received, and the event message is associated with tenant identifier SELLER-X and the event message is further associated with the topic identifier LISTING-CREATE, the routing row 401 then indicates that the received event message is to be forwarded to the LISTING-SERVICE capability.

It is to be appreciated that, although not shown, the routing table 400 may include an additional row that would cause the messaging fabric 104 to route another event message to an additional capability. Such may be the case where the additional row includes the topic LISTING-CREATE and the tenant identifier SELLER-X. In such cases, the routing table would indicate that a second event message is to be sent to additional capability. In this way, the messaging fabric 104 may transmit many outgoing event messages in response to receiving a single incoming event message.

### Example Event Message

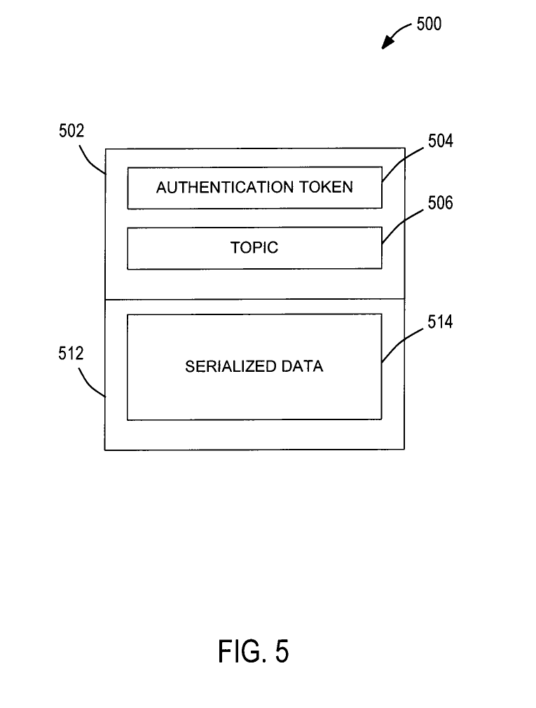

FIG. 5 is a block diagram that shows a format for an event message 500, according to an example embodiment. The event message 500 may be a loosely coupled event message. For example, the event message may not explicitly indicate a capability that is to receive the message, as may be indicated by a field that stores a destination identifier, address, or any other data that identifies the capability that is to receive the event message.

FIG. 5 shows that the event message 500 includes a header 502 and a payload 512. The header 502 includes fields that store data used by the messaging fabric 104 to properly route a received event message to the appropriate capabilities. In particular, as shown in FIG. 5, the event message may include an authentication token field 504 and a topic field 506. As will be explained below, the authentication token field 504 may store an authentication token specific to a particular tenant and capability. The authentication token sent in the authentication token field 504 may indicate that the specific capability is authorized to receive and/or transmit event messages on behalf of the specific tenant. In some embodiments, the authentication token may be a digitally signed token.

The topic field 506 is a field that characterizes the type of event message being sent or received. The topic field 506 may store a topic, such as a word, phrase, number, letter, symbol, or any combination thereof that has a particular meaning within the system 100, such as, for example, between capabilities and/or tenants. For example, the capabilities 101 and 102 may use the topic “ITEM-SALE” to tag event messages that relate to the sale of an item. Accordingly, the capability 101 may include the “ITEM-SALE” topic in an event message when the capability 101 want to send with information related to the sale of an item to the system 100. Further, capability 102 may be interested receiving event messages related to items sold in the system 100. Accordingly, the capability 102 may subscribe (e.g., under the direction of the tenant 110) with the messaging fabric 104 to receive event messages with the topic field 506 set to “ITEM-SALE.”

The payload 512 stores data that is specific to the event that generated the event message. Accordingly, the payload 512 stores the data that is to be used by the receiving capability to react to the event. In some embodiments, the message builder module 204 may serialize the payload of the data using Avro™

### Methods of Exchanging Event Messages

The message processing system 100 of FIG. 1 provides a processing flow for events in a loosely coupled, asynchronous fashion. In particular, each capability sends event messages through the messaging fabric without any logic or data that specifies the capabilities that are to receive the event message. Thus, as described above, the event messages are loosely coupled event messages. Such a loose coupling provides a number of technical advantages. For example, a tenant may utilize a number of capabilities with comparatively less integration. For example, the capabilities in system 100 are integrated with the messaging fabric rather than with each other. Such a technique allows a system to scale by adding additional capabilities without integrating the new capability with each capability that the new capability is to interact with.

Still further, the message processing system 100 exchanges event messages asynchronously. For example, in one embodiment, the capability 101 does not block until another component makes a request for a particular state (e.g., a set of items being listed). Instead, the capability 101 sends event messages to the message fabric 104, and in turn to capability 102, when certain conditions occur, such as a price change or a listing has been posted. Utilizing such asynchronous techniques may lead to further efficiencies because such asynchronous techniques may limit the number of requests a capability makes to determine whether new or fresh data is available.

This loosely coupled, asynchronous processing flow within the system 100 permits event messages to be detected, generated, housed, distributed, and processed in an asynchronous and concurrent fashion across a single machine or a plurality of machines communicating with one another across different host sites. This improves the efficiency of the resources of a business enterprise and reduces processing latency associated with processing business transactions.

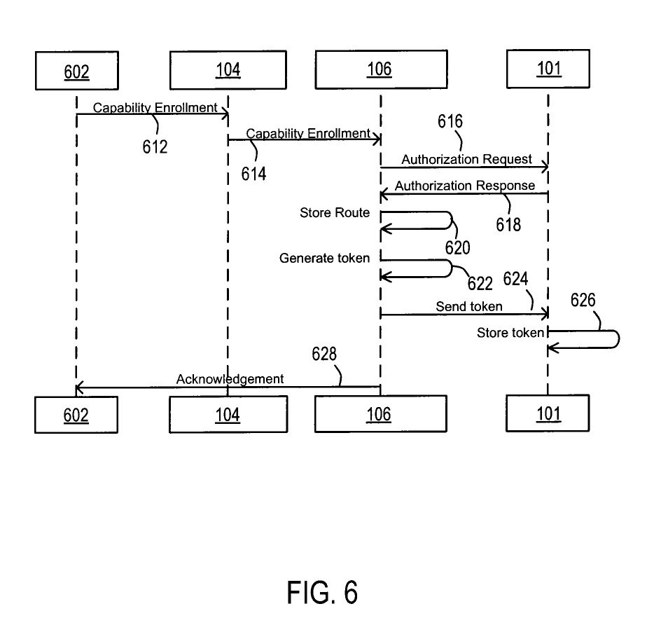

FIG. 6 is a diagram of a method 600 of negotiating authorization for a capability to publish and/or receive event messages on behalf of a tenant. Such a negotiation may be initiated by the tenant operating on a storefront 602. The storefront may be a hosted service that allows a tenant to enroll or otherwise authorize a capability to publish event messages within the system 100 on behalf of the tenant.

To begin, at operation 612, the storefront 602 may send a capability enrollment message to the messaging fabric 104. For example, the storefront 602 may list a number of capabilities available for the tenant to select and add to their commerce applications. Accordingly, upon the tenant selecting a particular capability (such as, e.g., eBay or Magento) through the user interface provided by the storefront 602, the storefront 602 may send the capability enrollment message to the messaging fabric 104. The capability enrollment message may include credentials associated with the user, such as a username, password, or identifier. In some embodiments, the credentials associated with the user may be specific to the capability that the tenant is authorizing.

The messaging fabric 104 may then route the capability enrollment message to the messaging manager 106. This is shown as operation 614.

Upon receiving capability enrollment message, the messaging manager 106 may send an enrollment authorization message, at operation 616, to the capability 101. In particular, the enrollment authorization message may indicate that the tenant is requesting that the capability provide a service on behalf of the tenant. For example, the enrollment authorization message may include credentials associated with the tenant, such as a username or password. The credentials, according to one embodiment, may be provided by the operation 612 and/or the operation 614. In another embodiment, the enrollment authorization message may cause the capability 101 to redirect the tenant to a login page so that the capability 101 may verify that the tenant has an account with the tenant 101.

At operation 618, responsive to the capability 101 receiving the authorization message, the capability 101 may send an authorization response message to the messaging manager 106. The authorization response message may indicate whether the capability 101 agrees to provide a particular service on behalf of the tenant. Providing a service on behalf of the tenant may include authorization to publish and receive event messages.

If the authorization response message indicates that the capability agrees to provide the particular service on behalf of the tenant, the messaging manager 106 then stores a message route for the capability, the tenant, and one or more topics. This is shown as operation 620. For example, with reference to FIG. 4, the messaging manager 106 may store a row that associates the capability 101 to one or more topics and to a tenant identifier associated with the tenant.

With reference back to FIG. 6, the messaging manager 106 may also generate an authorization token associated with the combination of the capability and the tenant. Generating the authorization token is shown as operation 622. After the messaging manager 104 generates the authorization token, the messaging manager 106 sends a token message to the capability 101 at operation 624. The capability 101, responsive to receiving the token message, may store the authorization token, as shown as operation 626.

At operation 628, the messaging manager 106 may also send an acknowledgement message to the storefront 602 to indicate that the capability 101 agrees to provide the specified service for the tenant. As described above, providing a service may involve sending and/or receiving event messages through the messaging fabric 104.

After the method 600 is performed, capability 101 is able to publish event messages on behalf of the authorized tenants. For example, after the method 600 is performed, the capability 101 may send an event message to the messaging fabric 104. The event message may include the authorization token so that the messaging fabric may validate that the capability 101 is authorized to send event messages on behalf of the tenant.

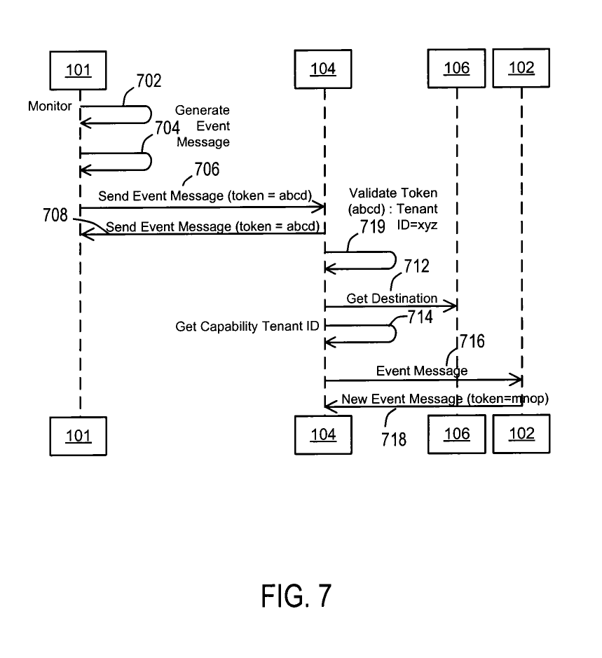

FIG. 7 is a sequence diagram that illustrates a method 700 for transmitting event messages between various capabilities through the messaging fabric 104, according to an example embodiment. The method 700 is implemented in a machine-accessible and/or readable medium and is accessible over a network. In an embodiment, the method 700 is performed by components shown in FIGS. 1, 2, and 3. It is to be appreciated that the method 700 may be processed across multiple processors and may be multithreaded, meaning that duplicate operations of the method 700 may be performed within the same computation environment and may cooperate with one another to perform the processing of the method 700 depicted in FIG. 7.

At operation 702, the capability 101 may monitor an electronic infrastructure for event conditions that trigger the capability 101 to send an event message to the messaging fabric 104. As described above, an event condition may refer to a change in a state of the business infrastructure or, in some cases, a request from a participant of the electronic infrastructure. For example, the event monitor module 202 may detect that the capability 101 received a request from a tenant to, for example, list an item for sale. As further illustration, the event monitor module 202 may detect that the price of an item has changed, an item has been sold, an order has been completed, an account as be created, a price comparison has been requested for a particular item, or any other state change occurring within the electronic infrastructure.

When such an event condition is detected, the event monitor module 202 may trigger the generation of one or more event messages to be sent to the messaging fabric 104. This is shown as operation 704. As described above, the message builder 204 may generate an event message. It is to be understood that the event message may be formatted according to a message definition, as may be maintained by the message builder module 204.

The event message may include a header and a payload. As described above, with reference to FIG. 5, a header may refer to supplemental data included in the event message that the messaging fabric uses to determine destination points for the event message. For example, the event message header may include an authentication token, a topic, a timestamp for the commerce event, and any other suitable information.

The authorization token may be specific to a tenant-capability relationship. For example, the capability 101 may use the authorization token received from the messaging fabric 104 and/or messaging manager 106, according to the method 600 described above. As described above with reference to the method 600, the authentication token sent to the capability indicates that the capability 101 is authorized to send event messages for the tenant 110.

Although the method 700 will be described as a method for communicating loosely coupled event messages, it should be noted that some embodiments may include a destination field in the event message header to explicitly identify a capability that is to receive the event message. Such a destination field allows point-to-point messaging through the messaging fabric. For example, a capability offering storefront services may generate an event message according to a format specific to a listing service, e.g., eBay. Accordingly, the multi-market place may then set a value in the header that indicates to the messaging fabric that the event message is to be sent to the specific capability offering the listing service.

The event message payload may be data that is to be delivered to a receiving capability. For example, the event message payload may characterize a specific event detected by the capability 101. As an illustration, the event message payload may include data regarding an item that may be listed in a multi-market place, or may describe an order that has been completed. In an example embodiment, the message builder module 204 may serialize the payload of the data using Avro™. Serializing the payload with a protocol such as Avro™ formats the payload in a comparatively compact binary form.

At operation 706, after the event message is generated, capability 101 may send the event message to the messaging fabric 104 in response to detecting the event condition. As FIG. 7 shows, the event message includes the authorization token specific to the capability-tenant. FIG. 6, and its corresponding description, describes an example method for generated the capability-tenant specific token. The event message may be sent as an HTTP request message.

Upon receiving the event message sent at operation 706, the messaging fabric 104 may send an acknowledgement response. This is shown as operation 708. An HTTP response with code 200 is an example of an acknowledgement response that the messaging fabric may send back to the capability. It is to be appreciated that the messaging fabric 104 provides an asynchronous messaging system. Thus, the capability does not block for a return result from the event message sent at operation 706. In some embodiments, the messaging fabric 104 may close the HTTP connection used to transmit the messages received and sent at operations 706 and 708.

At operation 710, the messaging fabric 104 may validate the event message received from the capability 101. For example, the messaging fabric 104 may parse the header of the event message to obtain the authentication token. The messaging fabric 104 may then validate that the authentication token is the authentication token previously sent to the capability when the messaging fabric authorized the capability 101 to send event messages on behalf of a particular tenant. If the authorization token was previously assigned to the capability, then the messaging fabric 104 can infer that the event message is being sent on behalf of the particular tenant.

Based on detecting that the authorization token is valid, the messaging fabric 104, at operation 712, may obtain the destination of the event message. For example, the messaging fabric 104 may query the messaging manager 106 to return the destinations of the event message based on the topic and tenant identifier associated with the event message. For example, the messaging manager 106 may return the capability identifiers associated with rows that include a matching topic and a matching tenant identifier fields.

In some embodiments, the messaging fabric 104 may maintain pseudonymous tenant identifiers. A “pseudonymous tenant identifier,” as used herein, may refer to a tenant identifier that is associated with a specific capability. Thus, a specific tenant may be assigned a unique and separate tenant identifier for each capability the tenant is associated with. In this way, a tenant identifier used by one capability does not refer to the same tenant in a different capability. This adds an additional layer of protection.

In embodiments that use pseudonymous tenant identifiers, at operation 714, the messaging fabric 104 may transform the tenant identifiers into a capability specific tenant identifier for each of the capabilities determined to be a destination for the event message. For example, each capability may be associated with a one-way hash, and the messaging fabric 104 may used the one-way hash to generate capability specific tenant identifiers. In this way, a first and second capability may identify the same tenant with different tenant identifiers.

At operation 716, an event message is forwarded to each of the destination capabilities (e.g., capability 102) previously obtained at operation 712. In particular, the event messages sent at operation 716 include the original payload of the event message sent at operation 706. Further, each of the event messages sent at operation 716 includes the pseudonymous tenant identifier that is specific to the particular capability.

At operation 718, the capability then provides a service based on the event message received from the messaging fabric 104. As part of operation 718, the capability 102 de-serializes the payload according to a message definition, as may be associated with a particular topic. As explained above, the payload data may include data about a recent order, an item listed for sale, a bid on an item for sale, an interest in an item (e.g., a price check), or any other event.

It is to be appreciated that providing the service at operation 718 may cause the capability to send out another event message to the messaging fabric. This is shown at operation 720. As FIG. 7 shows, the other event message may include a token specific to the capability. In this way the token at operation 720 is different than the token at operation 706, because these operations involve different capabilities.

### Synchronous Bridge

In certain instances, it may be desirable for the capabilities to receive event messages from the messaging fabric 104 in a synchronous manner. Such may be the case because a capability may be a legacy system that receives messages based on requesting the data (e.g., using HTTP requests). However, from the perspective of the messaging fabric, asynchronous communication architectures may lead to more efficient processing. Such may be the case because the messaging fabric does not need to maintain HTTP persistent connections with each capability, for example. An asynchronous communication architecture may lead to further efficiencies because such an architecture may limit the number of requests a capability makes to determine whether new or fresh data is available.

To facilitate asynchronous communication from the perspective of the messaging fabric and synchronous communication from the capability's perspective, embodiments employ a synchronous bridge between the capability and the messaging fabric.

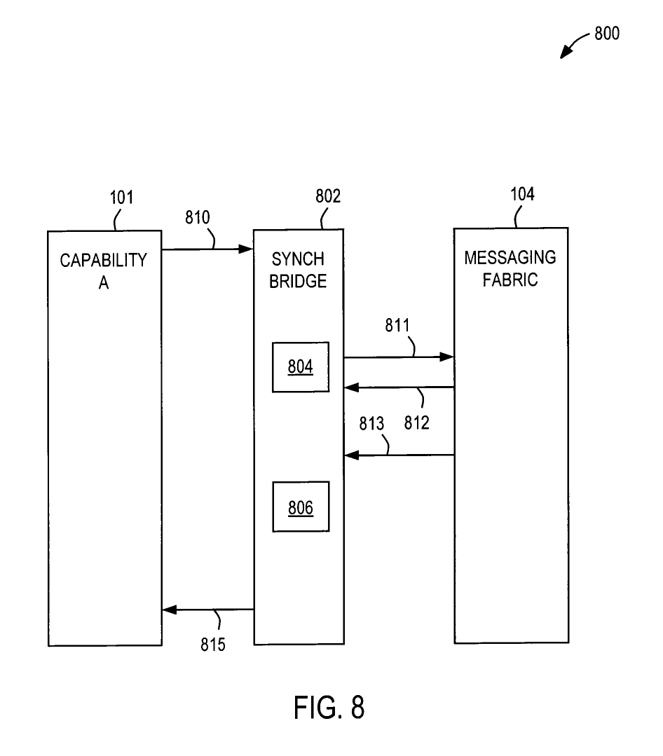

FIG. 8 is a block diagram that shows a system 800 that uses a synchronous bridge 802 to exchange event messages between the capability 101 and the messaging fabric 104, according to an example embodiment. The synchronous bridge 802 may be configured to allow the capability 101 to communicate synchronously, while, at the same time, allow the messaging fabric 104 to communicate asynchronously. As FIG. 8 shows, the synchronous bridge includes a connection module 804 and a correlation module 806. The connection module 804 maintains persistent connections with the capability sending a request to the messaging fabric 104.

The correlation module 806 may include logic and functionality to map event messages received from the messaging fabric 104 to an event message previously received from the capability 101. For example, the correlation module 806 may use event message definitions to define a subject of a message. For example, an event message definition may include fields that can be used to indicate a subject of an event message. A tenant, item, sales order, transaction number, or any other suitable data are all examples of a subject of an event message. Still further, an event definition may relate different types of event messages to each other. Such event types may characterize a request-response relationship between event messages. The topic defined in an event message header may be used as an event message type. To illustrate a relationship between different types of event messages, the correlation module 806 may include an event message definition that indicates that an event message with the topic of CREATE-LISTING (e.g., an event requesting the creation of a new listing) may result in an event message with the topic ITEM-CREATED (e.g., an event acknowledging that a particular item was created). Accordingly, where the synchronous bridge 802 receives the CREATE-LISTING event message and then ITEM-CREATED event message, the two event messages may be related if they refer to the same subject (e.g., the same tenant, item, sales order, transaction number, or any other suitable data).

Operationally, the capability 101 may publish an event message to the synchronous bridge 802. This is shown as event message 810. Responsive to receiving the event message 810, the synchronous bridge 802 may parse the event message 810 to determine the subject of the event message. For example, a tenant, item, sales order, transaction number, or any combination thereof may be used to determine the subject of the event message. Thus, data from the header and/or payload of an event message may be used to determine the subject of the event message.

Once the synchronous bridge 802 determines the subject of the event message, the synchronous bridge 802 then routes the event message to the messaging fabric 104. The forwarded event message is shown as event message 811.

As described above, the messaging fabric 104 provides asynchronous communications and, as a result, may respond to the event message 811 with an acknowledgement response 812. The acknowledge response 812, according to some embodiments, is a message that indicates that the messaging fabric 104 received the published event message. An HTTP response message with a response code set to ‘200’ is an example of an acknowledgement response message 812. Accordingly, the acknowledgement response message 812 may not indicate a response from a capability that processes the forwarded event message 811.

In some embodiments, after the acknowledgement response message 812 is sent, the synchronous bridge 802 and/or the messaging fabric 104 may close the connection used to send messages 811 and 812.

After some time, for example after another capability receives the event message, the messaging fabric 104 may send a second event message to the synchronous bridge 802. The second event message is shown as message 813. It should be noted that the second event message may result in a new connection between the synchronous bridge and the messaging fabric 104. Although not shown in FIG. 8, responsive to receiving the second event message 813, the synchronous bridge may send a second acknowledgment message to the messaging fabric 104.

Further, in response to receiving the second event message 813, the synchronous bridge 802 (e.g., the correlation module 806) may determine that the second event message 813 is related to the first event message 810. For example, the event message definitions may relate the first event message to the second event message. Such may be the case where the first event message may be associated with a first event message type (e.g., CREATE-LISTING) that may result in a response message of a second event message type (e.g., ITEM-CREATED).

Still further, the synchronous bridge 802 (e.g., the correlation module 806) may determine that the first and second event messages relate to the same subject. As described above, two event messages may relate to the same subject if they involve the same tenant, item, sales order, transaction number, or any other suitable data.

Responsive to determining that the two event messages are related (based on the event message definitions and/or the subjects of the messages), the synchronous bridge may then route the event message to the capability 101 using the connection used to receive the event message 810. This is shown as event message 815. In some embodiments, the connection used to communicate event messages 810 and 815 may be closed after the synchronous bridge sends event message 815.

In some embodiments, the synchronous bridge 802 may include an intelligent cache. An intelligent cache may store event messages in a way that allows other capabilities to query the status of previously received event messages. Such may be the case where the capability is designed to pull data from a data source, rather than receiving pushed data. In this way, the capability 101 may request an update for a particular order, for example, and the synchronous bridge may retrieve the appropriate data based on the subject of the event messages received from the messaging fabric 104.

### Message Relay

In certain instances, a technical feature may prevent a capability from receiving event messages from the messaging fabric. For example, a network firewall may prevent a tenant/capability from receiving messages delivered by an asynchronous messaging bus. Further, in another example, the IP address associated with an application may not be static and, as a result, the IP address used to register a capability may become stale.

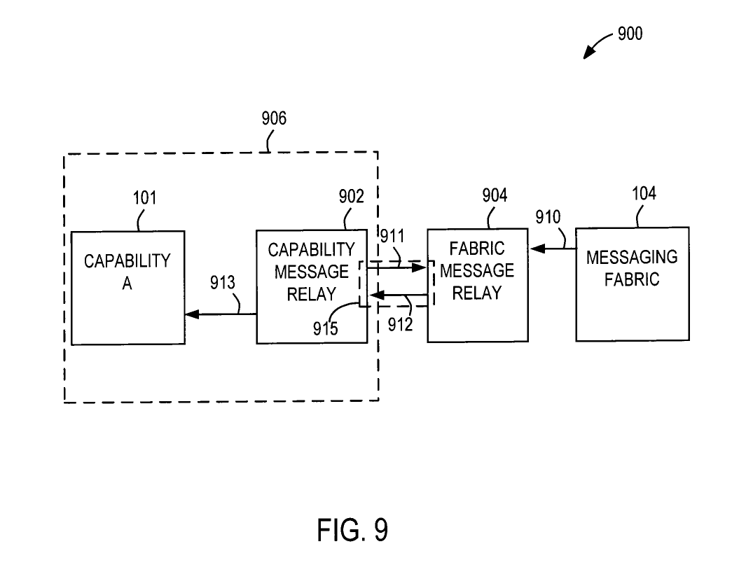

To overcome such technical shortcomings, embodiments may utilize a message relay to connect to the asynchronous messaging bus and receive messages from the asynchronous messaging bus. FIG. 9 is a block diagram that shows an example system 900 that utilizes such a message relay. As FIG. 9 shows, the system 900 may include a capability message relay 902 and a fabric message relay 904.

The fabric message relay 904 may be hosted by the provider of the messaging fabric 104. The fabric message relay 904 may provide a static IP address that the messaging fabric 104 uses to route an event message 910. The fabric message relay 904 then caches the received event message 910.

The capability message relay 902 may be hosted by the provider of the capability 101 within, for example, a firewall 906. The capability message relay 902 may be configured to periodically poll the fabric message relay 904 for event messages that should be routed to the capability 101. Such polling is shown as message 911. Responsive to the polling message 911, the fabric message relay 904 may send the received event message, as shown in message 912. The polling message 911 and polling response message 912 may be HTTP request and response messages, respectively, sent over the same HTTP connection 915.

The capability message relay 902 may then send an event message 913 to the capability 101. The event message 913 may include the event message 910 sent by the messaging fabric 104. Accordingly, the client-server relationship between the capability message relay 902 and the fabric message relay 904 may effectively bypass a firewall restriction using a normal HTTP request/response system where a client (e.g. capability message relay 902) polls for new messages. Still further, the use of the capability message relay 902 and the fabric message relay 904 allows the capability's IP address to change without requiring the capability to re-register with the messaging fabric 104.

### Example Commerce Systems

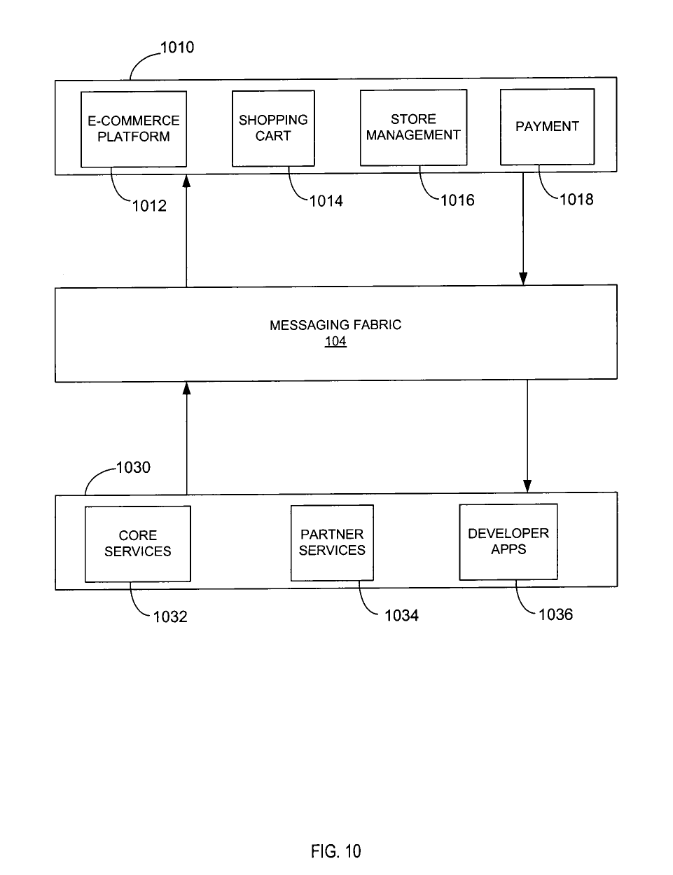

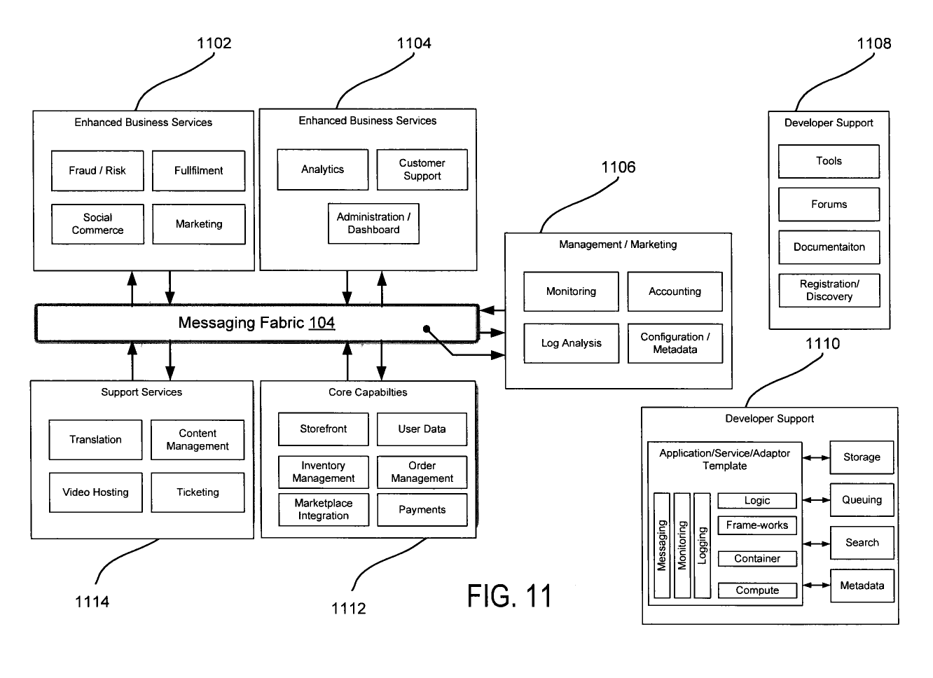

FIGS. 10-11 are now presented as example implementations of the event messaging processing techniques presented herein. It is understood that these example architectures and arrangements are presented for purposes of illustration only and are not intended to limit other implementations of the teachings presented.

FIG. 10 is a diagram of example network-based commerce system or facility 1000 which implements various embodiments associated with the invention. A commerce system 1000, in the example form of a network-based marketplace, provides a number of external interfaces 1010 that communicate with a number of capabilities 1030 through the messaging fabric 104.

The external interfaces 1010 may provide an interface into the service provided by the commerce system to a consumer or merchant. For example, the external interfaces 1010 may include an e-commerce platform 1012 (e.g., MAGENTO), an e-shopping cart 1014, an online store management software 1016 (e.g., OS COMMERCE), and a payment interface 1018 (e.g., PRESTO). One or more of the external interfaces may connect to the capabilities 130 through the messaging fabric. As FIG. 10 shows, the capabilities 1030 may include core service 1032 (e.g., services offered by the provider of the commerce system 1000 or messaging fabric 104), partner service 1034 (e.g., services provided by third parties), and developer applications 1036 (e.g., application developed by application developers).

In some embodiments, the external interfaces may provide an end-user the option of integrating the services offered by the capabilities 1030 into the external interface. In other embodiments, a developer of the external interface itself may associate a feature provided through the external interface by a service performed by a capability. Thus, there may be a many-to-many mapping between the individual external interfaces and the capabilities. However, rather than requiring point-to-point integration, the messaging fabric 104 provides a loosely coupled integration platform where each of the external interfaces 1010 and capabilities 1030 simply integrate with the messaging fabric 104.

FIG. 11 is a diagram that illustrates, for example, a number of services that may be communicatively connected to the messaging fabric. In particular, the messaging fabric 104 may be communicatively coupled to enhanced business services 1102, merchant support 1104, management and metering services 1106, support services 114, and core capabilities 1112.

Still further, the support system 1100 may provide developer support 1108 and a capability interface 1110. The developer support 1108 may include tools, forums, documentation, and a registry that a developer can use to develop their third party application that may be integrated in the messaging fabric 104. The capability interface 1110 may include a framework and/or services that a developer can use to operate their application in such a way as to be integrated and compliant with a messaging fabric 104. Such a capability interface may substantially reduce the overhead for third party developers to integrate existing applications into the messaging fabric 104.

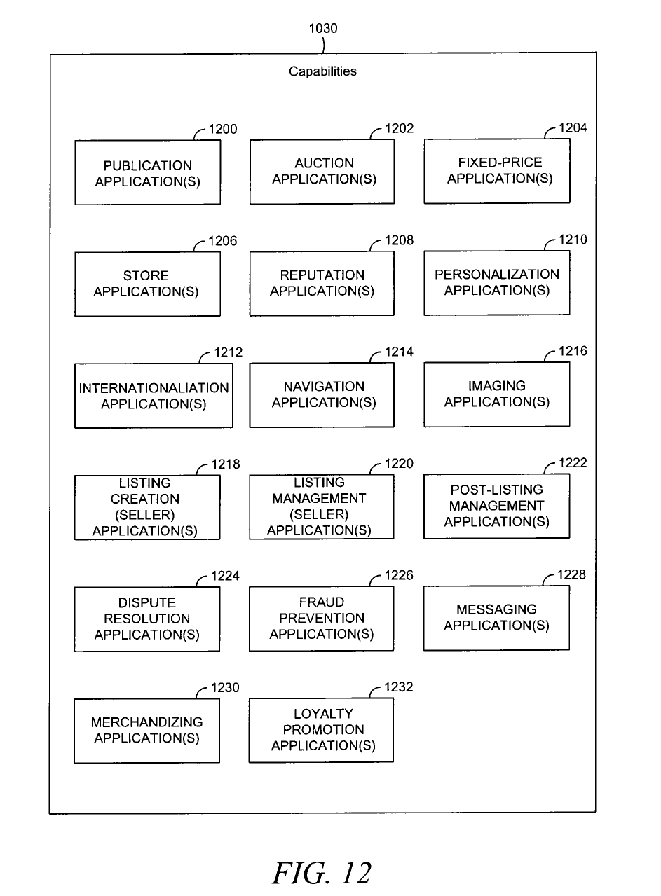

FIG. 12 is a diagram of example services 1200 implemented within some of the capabilities 1030 of the network-based commerce system 1000 of FIG. 10. The services 1200 may be hosted on dedicated or shared server machines (not shown) that are communicatively coupled to enable communications between server machines. The architecture of one such example server machine is provided below. The applications themselves are communicatively coupled (e.g., via appropriate interfaces) to each other and to various data sources, so as to allow information to be passed between the applications or so as to allow the applications to share and access common data.

The networked system 1000 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the capabilities 1030 are shown to include at least one publication application 1200 and one or more auction applications 1202 which support auction-format listing and price setting mechanisms (e.g., English, Dutch, Vickrey, Chinese, Double, Reverse auctions etc.). The various auction applications 1202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1206 allow a seller to group listings within a “virtual” store, which may be branded and otherwise personalized by and for the seller. Such a virtual store may also offer promotions, incentives and features that are specific and personalized to a relevant seller.

Reputation applications 1208 allow users that transact, utilizing the networked system 1000, to establish, build and maintain reputations, which may be made available and published to potential trading partners. Consider that where, for example, the networked system 1000 supports person-to-person trading, users may otherwise have no history or other reference information whereby the trustworthiness and credibility of potential trading partners may be assessed. The reputation applications 1208 allow a user, for example through feedback provided by other transaction partners, to establish a reputation within the networked system 1000 over time. Other potential trading partners may then reference such a reputation for the purposes of assessing credibility and trustworthiness.

Personalization applications 1210 allow users of the networked system 1000 to personalize various aspects of their interactions with the networked system 1000. For example a user may, utilizing an appropriate personalization application 1210, create a personalized reference page at which information regarding transactions to which the user is (or has been) a party may be viewed. Further, a personalization application 1210 may enable a user to personalize listings and other aspects of their interactions with the networked system 1000 and other parties.

The networked system 1000 may support a number of marketplaces that are customized, for example, for specific geographic regions. A version of the networked system 1000 may be customized for the United Kingdom, whereas another version of the networked system 1000 may be customized for the United States. Each of these versions may operate as an independent marketplace, or may be customized (or internationalized) presentations of a common underlying marketplace. The networked system 1000 may accordingly include a number of internationalization applications 1212 that customize information (and/or the presentation of information) by the networked system 1000 according to predetermined criteria (e.g., geographic, demographic or marketplace criteria). For example, the internationalization applications 1212 may be used to support the customization of information for a number of regional websites that are operated by the networked system 1000 and that are accessible via respective web servers.

Navigation of the networked system 1000 may be facilitated by one or more navigation applications 1214. For example, a search application (as an example of a navigation application) may enable key word searches of listings published via the networked system 1000. A browse application may allow users to browse various category, catalogue, or inventory data structures according to which listings may be classified within the networked system 1000. Various other navigation applications may be provided to supplement the search and browsing applications.

In order to make listings, available via the networked system 1000, as visually informing and attractive as possible, the capabilities 1030 may include one or more imaging applications 1216 utilizing which users may upload images for inclusion within listings. An imaging application 1216 also operates to incorporate images within viewed listings. The imaging applications 1216 may also support one or more promotional features, such as image galleries that are presented to potential buyers. For example, sellers may pay an additional fee to have an image included within a gallery of images for promoted items.

Listing creation applications 1218 allow sellers conveniently to author listings pertaining to goods or services that they wish to transact via the networked system 1000, and listing management applications 1220 allow sellers to manage such listings. Specifically, where a particular seller has authored and/or published a large number of listings, the management of such listings may present a challenge. The listing management applications 1220 provide a number of features (e.g., auto-relisting, inventory level monitors, etc.) to assist the seller in managing such listings. One or more post-listing management applications 1222 also assist sellers with a number of activities that typically occur post-listing. For example, upon completion of an auction facilitated by one or more auction applications 1202, a seller may wish to leave feedback regarding a particular buyer. To this end, a post-listing management application 1222 may provide an interface to one or more reputation applications 1208, so as to allow the seller conveniently to provide feedback regarding multiple buyers to the reputation applications 1208.

Dispute resolution applications 1224 provide mechanisms whereby disputes arising between transacting parties may be resolved. For example, the dispute resolution applications 1224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 1226 implement fraud detection and prevention mechanisms to reduce the occurrence of fraud within the networked system 1000.

Messaging applications 1228 are responsible for the generation and delivery of messages to users of the networked system 1000, such messages for example advising users regarding the status of listings at the networked system 1000 (e.g., providing “outbid” notices to bidders during an auction process or to provide promotional and merchandising information to users). Respective messaging applications 1228 may utilize any one of a number of message delivery networks and platforms to deliver messages to users. For example, messaging applications 1228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1230 support various merchandising functions that are made available to sellers to enable sellers to increase sales via the networked system 1000. The merchandising applications 1230 also operate the various merchandising features that may be invoked by sellers, and may monitor and track the success of merchandising strategies employed by sellers.

The networked system 1000 itself, or one or more parties that transact via the networked system 1000, may operate loyalty programs that are supported by one or more loyalty/promotions applications 1232. For example, a buyer may earn loyalty or promotions points for each transaction established and/or concluded with a particular seller, and be offered a reward for which accumulated loyalty points can be redeemed.

### Example Computer Systems

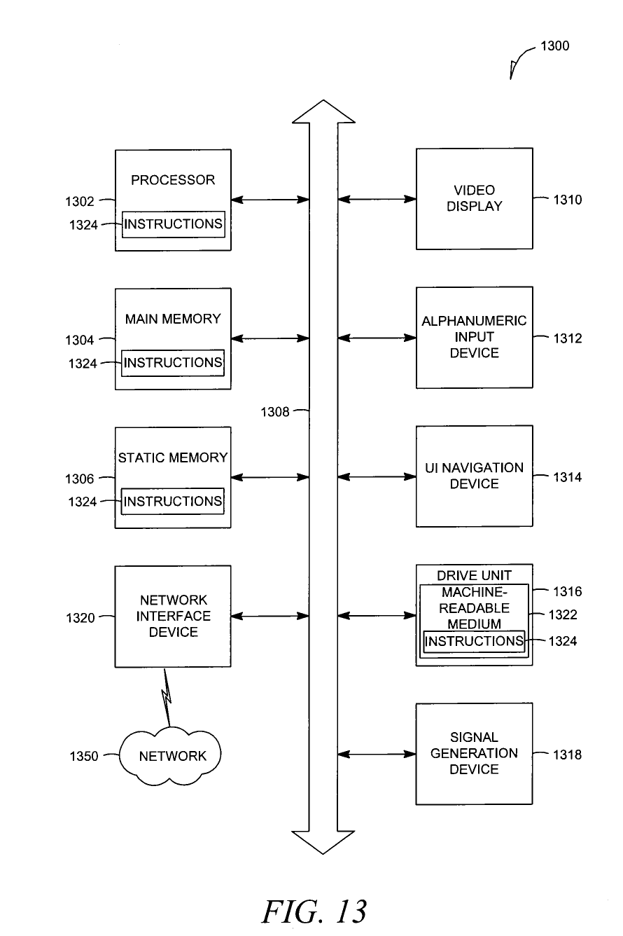

FIG. 13 is a diagram of machine architecture 1300 which implements various aspects of the invention, according to an example embodiment. The machine includes a set of instructions, which when executed on the machine cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer architecture 1300 includes a processor 1302 (e.g., a central processing unit (CPU) a graphics processing unit (GPU) or both), a main memory 1304 and a static memory 1306, which communicate with each other via a bus 1308. The architecture 1300 may further include a video display unit 1310 (e.g., a liquid crystal display (LCD) or a cathode ray tube (CRT)). The architecture 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320.

The disk drive unit 1316 includes a machine-readable medium 1322 on which is stored one or more sets of instructions (e.g., software 1324) embodying any one or more of the methodologies or functions described herein. The software 1324 may also reside, completely or at least partially, within the main memory 1304 and/or within the processor 1302 during execution thereof by the architecture 1300, the main memory 1304 and the processor 1302 also constituting machine-readable media.

The software 1324 may further be transmitted or received over a network 826 via the network interface device 1320.

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide novel business event processing have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system, comprising:
at least one processor; and
a communication module implemented by the at least one processor and communicatively coupled to a first capability and a second capability, the communication module configured to receive an event message from the first capability, the event message including a header and a payload; and
an event message handler implemented by the at least one processor and configured to:
parse the header of the event message to identify a topic of the event message,
identify a tenant identifier associated with the event message,
determine that the second capability is to receive the event message based on the topic and the tenant identifier, and
cause the communication module to send the event message to the second capability.

2. The system of claim 1, further comprising:
a processor-implemented negotiation module configured to:
receive an enrollment request from a tenant to authorize the first capability to send event messages on behalf of the tenant,
send an authorization request to the first capability to determine whether the first capability agrees to send the event messages on behalf of the tenant,
receive an authorization response that indicates that the first capability agrees to send the event messages, and
send an authorization token to the first capability, the authorization token being specific to the first capability and the tenant.

3. The system of claim 1, wherein the event message handler identifies the tenant identifier based on an authorization token sent in the event message, the authorization token being specific to the tenant and the first capability.

4. The system of claim 1, wherein the event message is asynchronously distributed from the first capability and asynchronously sent to the second capability.

5. The system of claim 1, wherein the event message handler is configured to determine that the second capability is to receive the event message by accessing a routing data store that associates topics and tenant identifiers to capabilities.

6. The system of claim 1, wherein:
the communication module is further communicatively coupled to a third capability; and
the event message handler is further configured to determine that the third capability is to receive the event message, in addition to the second capability, based on the topic and the tenant identifier.

7. The system of claim 1, wherein the event message handler is further configured to send an HTTP response message with a status code that indicates that the event message was successfully received.

8. A computer-implemented method, comprising:
receiving an event message from a first capability, the event message including a header and a payload;
parsing, by a processor, the header of the event message to identify a topic of the event message;
identifying, by the processor, a tenant identifier associated with the event message;
determining, by the processor, that a second capability is to receive the event message based on the topic and the tenant identifier; and
sending the event message to the second capability.

9. The computer-implemented method of claim 8, further comprising:
receiving an enrollment request from a tenant to authorize the first capability to send event messages on behalf of the tenant;
sending an authorization request to the capability to determine whether the first capability agrees to send the event messages on behalf of the tenant;
receiving an authorization response that indicates that the first capability agrees to send the event messages on behalf of the tenant; and
sending an authorization token to the first capability, the authorization token being specific to the first capability and the tenant.

10. The computer-implemented method of claim 8, wherein the identification of the tenant identifier is based on an authorization token sent in the event message, the authorization token being specific to the tenant and the first capability.

11. The computer-implemented method of claim 8, wherein the event message is asynchronously distributed from the first capability and asynchronously sent to the second capability.

12. The computer-implemented method of claim 8, wherein the determining that the second capability is to receive the event message further comprises accessing a routing data store that associates topics and tenant identifiers to capabilities.

13. The computer-implemented method of claim 8, further comprising determining that a third capability is to receive the event message, in addition to the second capability, based on the topic and the tenant identifier.

14. The computer-implemented method of claim 8, further comprising sending an HTTP response message with a status code that indicates that the event message was successfully received in response to receiving the event message.

15. A machine-readable storage medium storing a set of instructions that, when executed by at least one processor, causes the at least one processor to perform operations comprising:
receiving an event message from a first capability, the event message including a header and a payload;
parsing the header of the event message to identify a topic of the event message;
identifying a tenant identifier associated with the event message;
determining that a second capability is to receive the event message based on the topic and the tenant identifier; and
sending the event message to the second capability.

16. The machine-readable storage medium of claim 15, further comprising:
receiving an enrollment request from a tenant to authorize the first capability to send event messages on behalf of the tenant;
sending an authorization request to the capability to determine whether the first capability agrees to send the event messages on behalf of the tenant;
receiving an authorization response that indicates that the first capability agrees to send the event messages on behalf of the tenant; and
sending an authorization token to the first capability, the authorization token being specific to the first capability and the tenant.

17. The machine-readable storage medium of claim 15, wherein the identification of the tenant identifier being based on an authorization token sent in the event message, wherein the authorization token is specific to the tenant and the first capability.

18. The machine-readable storage medium of claim 15, wherein the event message is asynchronously distributed from the first capability and asynchronously sent to the second capability.

19. The machine-readable storage medium of claim 15, wherein the determining that the second capability is to receive the event message based on the topic and the tenant identifier further includes accessing a routing data store that associates topics and tenant identifiers to capabilities.

20. The machine-readable storage medium of claim 15, further comprising determining that a third capability is to receive the event message, in addition to the second capability, based on the topic and the tenant identifier.

21. The machine-readable storage medium of claim 15, further comprising sending an HTTP response message with a status code that indicates that the event message was successfully received in response to receiving the event message.
